(19) United States
(12) Patent Application Publication
(10) Pub. No.: US 2004/0157004 A1
(43) Pub. Date: Aug. 12, 2004

(54) Process of producing circularly-polarized-light-separating element

(75) Inventor: Masanori Umeya, Shinjuku-ku (JP)

Correspondence Address: PARKHURST & WENDEL, L.L.P., 1421 PRINCE STREET, SUITE 210, ALEXANDRIA, VA, 22314-2805, US

(73) Assignee: Dai Nippon Prtg. Co., Ltd., Shinjuku-ku (JP)

(21) Appl. No.: 10/691,972

(22) Filed: Oct. 24, 2003

(30) Foreign Application Priority Data
Oct. 30, 2002 (JP) 2002-315829

(51) Int. Cl. B05D 3/00

(52) U.S. Cl. 427/553

(57) ABSTRACT

The present invention provides a process of producing a circularly-polarized-light-separating element, through which a circularly-polarized-light-separating element in the form of a thin film, and excellent in efficiency of reflection, can be easily and effectively produced. A cholesteric liquid crystal solution is firstly applied to a glass substrate 11 having alignment power by the use of a spinner or the like to form a film 13 (FIG. 1(a)). The film 13 of the cholesteric liquid crystal solution is then heated, thereby obtaining an uncured cholesteric liquid crystal film 14 (FIG. 1(b)). Thereafter, the uncured cholesteric liquid crystal film 14 formed on the glass substrate 11 is left as it is at room temperature for a predetermined period of time so that liquid crystalline molecules in the cholesteric liquid crystal film 14 are aligned to form a cholesteric phase with the liquid crystalline molecules in planar orientation (FIG. 1(c)). While holding the phase of the uncured cholesteric liquid crystal film 14 to a supercooled cholesteric one at room temperature, ultraviolet light is applied to this film 14 in an atmosphere of nitrogen, whereby a cured cholesteric liquid crystal film 15 is obtained (FIG. 1(d)). There is thus produced a single-layer circularly-polarized-light-separating element 10 comprising the cholesteric liquid crystal film 15 laminated to the glass substrate 11 (FIG. 1(e)).

### BACKGROUND OF THE INVENTION

1. Field of the Invention

The present invention relates to a circularly-polarized-light-separating element for use in a liquid crystal display or the like, and particularly to a process of producing a circularly-polarized-light-separating element in the form of a thin film, and excellent in efficiency of reflection.

2. Description of Related Art

A circularly-polarized-light-separating element comprising a liquid crystal film with cholesteric regularity (cholesteric liquid crystal film), having the function of reflecting, in a predetermined reflection wave range, either right- or left-handed circularly polarized light with a wavelength equal to the pitch of the helix in the liquid crystal film and of transmitting the other light, has been known as the above-described circularly-polarized-light-separating element. In this specification, the term “liquid crystal film” is used to indicate a film that has the liquid crystalline properties in the optical sense, and the phase of such a film includes a liquid crystal phase with fluidity, as well as a solid phase obtained by solidifying a liquid crystal phase while retaining the molecular orientation in it.

Usually adopted as a process of producing such a circularly-polarized-light-separating element is a manner that a cholesteric liquid crystal solution containing a radiation-polymerizable cholesteric liquid crystalline material is applied to form an uncured cholesteric liquid crystal film, which is then cured by the application of radiation. In this process, it is necessary to bring the phase of the uncured cholesteric liquid crystal film to be cured in the above-described manner to a cholesteric one. For this purpose, radiation is usually applied to the uncured cholesteric liquid crystal film while heating it at a temperature above the lower limit (e.g., 70° C.) of a temperature range in which liquid crystalline molecules in the liquid crystal film form a cholesteric phase.

However, the above-described process of producing a circularly-polarized-light-separating element has the following drawback: a cholesteric liquid crystal film obtained through this process cannot have sufficiently high efficiency of reflection, so that, in order to obtain the desired reflectance for circularly polarized light, it is necessary to make the thickness of the cholesteric liquid crystal film excessively great. It should be noted that, since a circularly-polarized-light-separating element comprising such a cholesteric liquid crystal film is used finally in a liquid crystal display or the like, the thickness of the cholesteric liquid crystal film is preferably as small as possible.

### SUMMARY OF THE INVENTION

The present invention has been accomplished under these circumstances. An object of the present invention is to provide a process of producing a circularly-polarized-light-separating element, through which a circularly-polarized-light-separating element in the form of a thin film, and excellent in efficiency of reflection, can be easily and effectively produced.

The present invention provides a process of producing a circularly-polarized-light-separating element, comprising: a first step of applying, to a substrate having alignment power, a cholesteric liquid crystal solution prepared by dissolving a radiation-polymerizable cholesteric liquid crystalline material in a solvent, thereby forming a film; a second step of removing the solvent from the film formed in the first step, thereby obtaining an uncured cholesteric liquid crystal film; and a third step of applying, for curing, radiation to the uncured cholesteric liquid crystal film formed in the second step, while holding the phase of the uncured cholesteric liquid crystal film to a supercooled cholesteric one, thereby obtaining a cured cholesteric liquid crystal film.

In the present invention, it is preferable, in the third step, to hold the phase of the uncured cholesteric liquid crystal film formed in the second step to a supercooled cholesteric one with liquid crystalline molecules in planar orientation.

In addition, in the third step, it is preferable to hold the uncured cholesteric liquid crystal film formed in the second step at a temperature that is 30-90° C., more preferably 40-70° C., lower than the lower limit of a temperature range in which liquid crystalline molecules in the liquid crystal film form a non-supercooled cholesteric phase.

Furthermore, it is preferable that the process further comprises, between the second and third steps, a fourth step of leaving, as it is, the uncured cholesteric liquid crystal film formed in the second step for a predetermined period of time so that the phase of this film is brought to a supercooled cholesteric one with liquid crystalline molecules in planar orientation.

In the fourth step, it is preferable to heat the uncured cholesteric liquid crystal film formed in the second step.

Furthermore, it is preferable that the process further comprises: a fifth step of applying, to the cured cholesteric liquid crystal film obtained in the third step, an additional cholesteric liquid crystal solution prepared by dissolving a radiation-polymerizable cholesteric liquid crystalline material in a solvent, thereby forming an additional film; a sixth step of removing the solvent from the additional film formed in the fifth step, thereby obtaining an uncured additional cholesteric liquid crystal film; and a seventh step of applying, for curing, radiation to the uncured additional cholesteric liquid crystal film formed in the sixth step, while holding the phase of this film to a supercooled cholesteric one, thereby obtaining a cured additional cholesteric liquid crystal film.

Also in the seventh step, it is preferable to hold the phase of the uncured additional cholesteric liquid crystal film formed in the sixth step to a supercooled cholesteric one with liquid crystalline molecules in planar orientation. In addition, also in the seventh step, it is preferable to hold the uncured cholesteric liquid crystal film formed in the sixth step at a temperature that is 30-90° C. lower than the lower limit of a temperature range in which liquid crystalline molecules in the liquid crystal film form a non-supercooled cholesteric phase.

According to the present invention, since a cured cholesteric liquid crystal film is obtained by applying ultraviolet light to an uncured cholesteric liquid crystal film formed on a substrate, while holding the phase of this film to a supercooled cholesteric one, it becomes possible to cure a cholesteric liquid crystal film, while effectively preventing increase in the number of three-dimensional cross-links between liquid crystalline molecules in the cholesteric liquid crystal film, or increase in the magnitude of thermal fluctuation of the liquid crystalline molecules, namely, while effectively preventing the cholesteric structure from being disordered. It is therefore possible to easily produce a cholesteric liquid crystal film excellent in efficiency of reflection. For this reason, the thickness of a cholesteric liquid crystal film that is required to obtain the desired reflectance for circularly polarized light can be made small, and it is therefore possible to easily and effectively produce a circularly-polarized-light-separating element in the form of a thin film, and excellent in efficiency of reflection.

Moreover, according to the present invention, since the temperature (curing temperature) at which ultraviolet light is applied to the uncured cholesteric liquid crystal film can be made relatively low, the cholesteric liquid crystal film does not thermally expand. It is therefore possible to accurately conduct patterning exposure (alignment exposure) even when it is conducted by the application of ultraviolet light.

### BRIEF DESCRIPTION OF THE DRAWINGS

FIG. 1 is a flow chart illustrating a process of producing a circularly-polarized-light-separating element according to an embodiment of the present invention;

FIG. 2 is a flow chart illustrating a process of producing a circularly-polarized-light-separating element according to another embodiment of the present invention; and

FIG. 3 is a graph showing a relationship between curing temperature and reflectance for circularly polarized light, obtained from the cholesteric liquid crystal films of the embodiments shown in FIGS. 1 and 2.

### DETAILED DESCRIPTION OF THE PREFERRED EMBODIMENTS

By referring to the accompanying drawings, embodiments of the present invention will be described hereinafter.

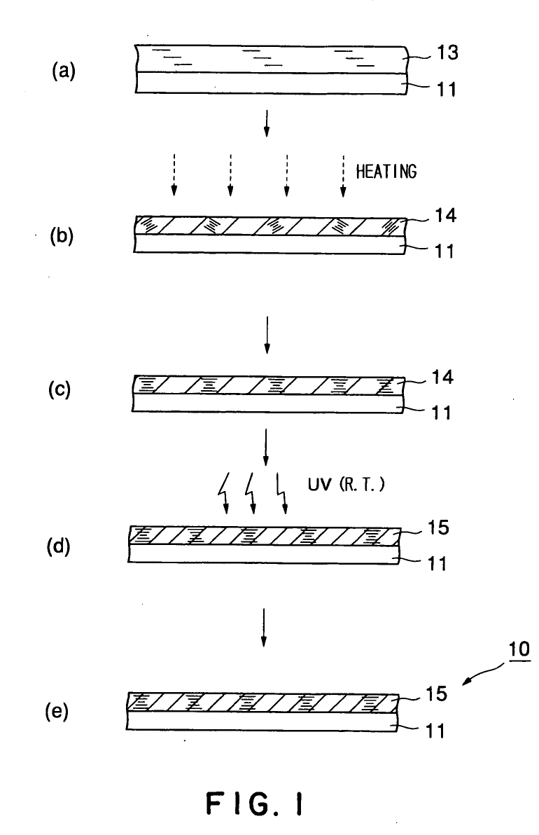

FIG. 1 is a flow chart illustrating a process of producing a circularly-polarized-light-separating element according to an embodiment of the present invention.

First of all, a glass substrate (base material) 11 having alignment power is prepared, and a cholesteric liquid crystal solution is applied to this glass substrate 11 by the use of a spinner or the like to form a film 13, as shown in FIG. 1(a). The cholesteric liquid crystal solution herein used is a solution containing an ultraviolet-polymerizable cholesteric liquid crystalline material (a chiral nematic liquid crystalline material containing a nematic liquid crystal and a chiral agent), a photopolymerization initiator, and a surface-active agent (leveling agent). Polymerizable monomeric or oligomeric liquid crystals may be used for the liquid crystalline material in the cholesteric liquid crystal solution. In the case where polymerizable monomeric liquid crystals are used, it is possible to use mixtures of liquid crystalline monomers and chiral compounds as described in Japanese Laid-Open Patent Publication No. 258638/1995 and Published Japanese Translation No. 508882/1998 of PCT International Publication for Patent Application. In the case where polymerizable oligomeric liquid crystals are used, it is possible to use cyclic organopolysiloxane compounds having cholesteric phases as described in Japanese Laid-Open Patent Publication No. 165480/1982. On the other hand, conventional photopolymerization initiators such as Irg 184, Irg 361, Irg 651 and Irg 907 (available from Ciba Specialty Chemicals K.K., Japan) may be used for the photopolymerization initiator in the cholesteric liquid crystal solution. Conventional surface-active agents such as Byk 390, Byk 352, Byk 356, Byk 359 and Byk 361 (manufactured by BYK-Chemie Japan K.K., Japan) may be used for the surface-active agent.

Next, as shown in FIG. 1(b), the film 13 of the cholesteric liquid crystal solution is heated at a temperature between 50° C. and 90° C. by a hot plate or the like in order to remove the solvent from the film 13 by evaporation, thereby obtaining an uncured cholesteric liquid crystal film 14.

Thereafter, as shown in FIG. 1(c), the uncured cholesteric liquid crystal film 14 formed on the glass substrate 11 is left as it is at room temperature (e.g., 25° C.) for a predetermined period of time, thereby aligning liquid crystalline molecules in the cholesteric liquid crystal film 14 so that the phase of the cholesteric liquid crystal film 14 is brought to a cholesteric one with the liquid crystalline molecules in planar orientation. In the step shown in FIG. 1(c), the cholesteric liquid crystal film 14 may be heated or shaken in order to more fully align liquid crystalline molecules in it. Further, the step shown in FIG. 1(c) is not necessarily essential and can be omitted if liquid crystalline molecules in the cholesteric liquid crystal film 14 are fully aligned in the step shown in FIG. 1(b).

While holding the phase of the uncured cholesteric liquid crystal film 14 to a supercooled cholesteric one at room temperature, ultraviolet light (radiation) is applied to this film 14 in an atmosphere of nitrogen, as shown in FIG. 1(d). Polymerization is thus initiated by both the photopolymerization initiator previously added and the ultraviolet light externally applied, to three-dimensionally cross-link (polymerize) liquid crystalline molecules in the uncured cholesteric liquid crystal film 14, thereby curing the uncured cholesteric liquid crystal film 14 to give a cured cholesteric liquid crystal film 15. By “three-dimensional cross-linking” is herein meant that liquid crystalline monomer or oligomer molecules are three-dimensionally polymerized to give a network structure. By bringing the liquid crystalline molecules to such a state, it is possible to optically fix them while retaining the molecular orientation in the liquid crystal phase, and is thus possible to obtain a film that is easy to handle as an optical film and stable at normal temperatures.

In the steps shown in FIGS. 1(c) and 1(d), in order to hold the phase of the uncured cholesteric liquid crystal film 14 to a supercooled cholesteric one, it is preferable to hold this film 14 at a temperature (curing temperature) that is 30-90° C., more preferably 40-70° C., lower than the lower limit of a temperature range in which liquid crystalline molecules in the cholesteric liquid crystal film 14 form a cholesteric phase (non-supercooled, ordinary cholesteric phase). The upper limit of a preferable supercooling temperature range is determined by the reflectance for circularly polarized light to be obtained, and the lower limit of the same is determined by the requirements of production process (avoidance of dew condensation, etc.). “Supercooled” means that even when a melted or fluid compound is cooled to a temperature below its phase transition temperature, it does not undergo phase transition and retains its original phase, and herein indicates that the cholesteric liquid crystal film 14 is cooled to a temperature lower than the intrinsic phase transition temperature (lower limit) of its cholesteric phase.

Thus, there is produced a single-layer circularly-polarized-light-separating element 10 comprising the cholesteric liquid crystal film 15 laminated to the glass substrate 11 (FIG. 1(e)).

According to this embodiment of the invention, since the cured cholesteric liquid crystal film 15 is obtained by applying ultraviolet light to the uncured cholesteric liquid crystal film 14 formed on the glass substrate 11, while holding the phase of this film 14 to a supercooled cholesteric one with liquid crystalline molecules in planar orientation, it becomes possible to cure the cholesteric liquid crystal film 14 while effectively preventing increase in the number of three-dimensional cross-links between liquid crystalline molecules in the cholesteric liquid crystal film 14, or increase in the magnitude of thermal fluctuation of the liquid crystalline molecules, namely, while effectively preventing the cholesteric structure from being disordered. It is therefore possible to easily produce a cholesteric liquid crystal film excellent in efficiency of reflection. For this reason, the thickness of the cholesteric liquid crystal film that is required to obtain the desired reflectance for circularly polarized light can be made small, and it is thus possible to easily and effectively produce a circularly-polarized-light-separating element in the form of a thin film, and excellent in efficiency of reflection.

Moreover, according to this embodiment, since the temperature (curing temperature) at which ultraviolet light is applied to the uncured cholesteric liquid crystal film 14 can be made relatively low, the cholesteric liquid crystal film 14 never thermally expands. It is therefore possible to conduct patterning exposure (alignment exposure) with high accuracy even when it is conducted by the application of ultraviolet light.

In the above-described embodiment, the atmosphere in which the cured cholesteric liquid crystal film 15 is, in the step shown in FIG. 1(d), obtained by the application of ultraviolet light is an atmosphere of nitrogen. However, this atmosphere is not limited to an atmosphere of nitrogen, and an atmosphere of any gas such as an atmosphere of air can be employed.

Further, although an ultraviolet-curing liquid crystalline material is used as the cholesteric liquid crystalline material in the aforementioned embodiment, it is also possible to use any of various liquid crystalline materials such as heat-curing liquid crystalline materials.

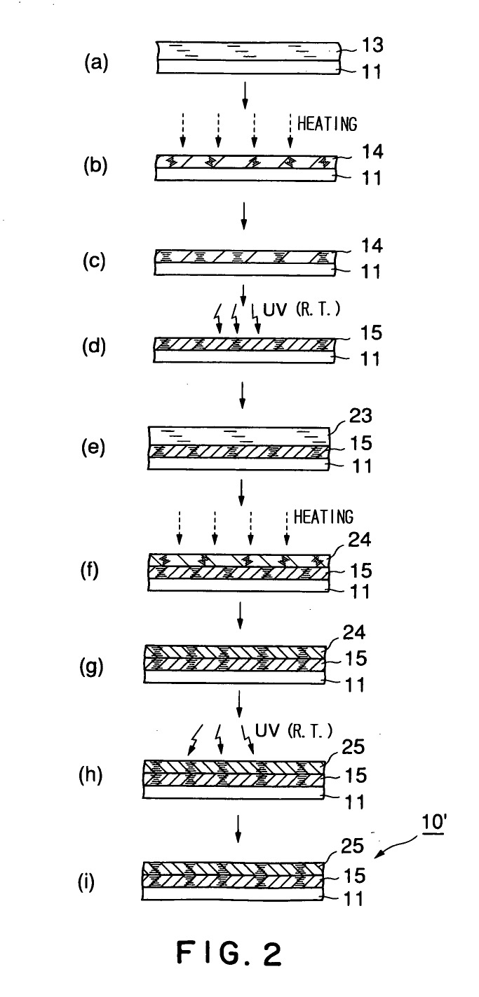

Furthermore, although the production of a single-layer circularly-polarized-light-separating element has been taken as an example for the description of the above embodiment, the present invention is not limited to this. As shown in FIGS. 2(a) to 2(i), if a cured cholesteric liquid crystal film 15 is formed on a glass substrate 11 through the same steps as those shown in FIGS. 1(a) to 1(d) (FIGS. 2(a) to 2(d)) and is then subjected to the same steps as those shown in FIGS. 1(a) to 1(d) (FIGS. 2(e) to 2(h)), there can be produced a two-layer circularly-polarized-light-separating element 10′ comprising two cholesteric liquid crystal films 15 and 25 laminated to the glass substrate 11 (FIG. 2(i)). It is also possible to produce a circularly-polarized-light-separating element composed of three or more layers by subjecting the upper most cholesteric liquid crystal film to the steps shown in FIGS. 2(e) to 2(h).

### EXAMPLES

Examples of the aforementioned embodiment will now be given together with Comparative Examples.

### Example 1

A 35% toluene solution of a cholesteric liquid crystal monomer (cholesteric liquid crystal solution) was prepared by blending an ultraviolet-curing nematic liquid crystal and a chiral agent. The amount of the chiral agent for the nematic liquid crystal was controlled so that the central wavelength of the selective reflection wave range of the cholesteric liquid crystal solution was 450 nm.

To this cholesteric liquid crystal solution were added, as the photopolymerization initiator, Irg 184 (available from Ciba Specialty Chemicals K.K., Japan) in an amount of 5% of the cholesteric liquid crystal and, as the surface-active agent, Byk 390 (manufactured by BYK-Chemie Japan K.K., Japan) in an amount of 0.06% of the cholesteric liquid crystal.

This cholesteric liquid crystal solution was applied, by the use of a spinner, to a glass substrate with an aligned polyimide film, and was then dried at a temperature of 90° C. in order to remove the solvent (toluene) from it, thereby obtaining an uncured cholesteric liquid crystal film.

The uncured cholesteric liquid crystal film was then cooled, together with the glass substrate, to room temperature (25° C.), whereby the phase of this film was brought to a supercooled cholesteric one.

Thereafter, the cholesteric liquid crystal film in such a state was placed in an atmosphere of nitrogen, and was irradiated, at a temperature of 25° C., with ultraviolet light with an irradiation power of 3.6 mW/cm² (310 nm) for 30 seconds.

Thus, there was obtained a circularly-polarized-light-separating element comprising the single cholesteric liquid crystal film (film thickness: approximately 1.25 μm). This circularly-polarized-light-separating element was found to have a reflectance of 80% for circularly polarized light in a reflection wave range centered at 450 nm.

### Example 2

In Example 2, a 35% toluene solution of a cholesteric liquid crystal monomer (cholesteric liquid crystal solution) was prepared by blending an ultraviolet-curing nematic liquid crystal and a chiral agent, as in the above-described Example 1. The amount of the chiral agent for the nematic liquid crystal was controlled so that the central wavelength of the selective reflection wave range of the cholesteric liquid crystal solution was 550 nm.

To this cholesteric liquid crystal solution were added, as the photopolymerization initiator, Irg 651 (available from Ciba Specialty Chemicals K.K., Japan) in an amount of 5% of the cholesteric liquid crystal, and, as the surface-active agent, Byk 352 (manufactured by BYK-Chemie Japan K.K., Japan) in an amount of 0.06% of the cholesteric liquid crystal.

This cholesteric liquid crystal solution was applied, by the use of a spinner, to a glass substrate with an aligned polyimide film, and a circularly-polarized-light-separating element comprising a single cholesteric liquid crystal film (film thickness: approximately 2 μm) was obtained in the same manner as in the aforementioned Example 1. This circularly-polarized-light-separating element was found to have a reflectance of 80% for circularly polarized light in a reflection wave range centered at 550 nm, like in Example 1.

### Example 3

In Example 3, a 35% toluene solution of a cholesteric liquid crystal monomer (cholesteric liquid crystal solution) was prepared by blending an ultraviolet-curing nematic liquid crystal and a chiral agent, as in the above-described Example 1. The amount of the chiral agent for the nematic liquid crystal was controlled so that the central wavelength of the selective reflection wave range of the cholesteric liquid crystal solution was 600 nm.

To this cholesteric liquid crystal solution were added, as the photopolymerization initiator, Irg 907 (available from Ciba Specialty Chemicals K.K., Japan) in an amount of 5% of the cholesteric liquid crystal, and, as the surface-active agent, Byk 352 (manufactured by BYK-Chemie Japan K.K., Japan) in an amount of 0.06% of the cholesteric liquid crystal.

This cholesteric liquid crystal solution was applied, by the use of a spinner, to a glass substrate with an aligned polyimide film, and a circularly-polarized-light-separating element comprising a single cholesteric liquid crystal film (film thickness: approximately 2.15 μm) was obtained in the same manner as in the aforementioned Example 1. This circularly-polarized-light-separating element was found to have a reflectance of 80% for circularly polarized light in a reflection wave range centered at 600 nm, like in Example 1.

### Example 4

In the above-described Examples 1 to 3, the temperature (curing temperature) at the time of application of ultraviolet light was fixed to room temperature (25° C.). In Example 4, on the contrary, a plurality of cholesteric liquid crystal films were formed by varying the curing temperature, and were used to obtain a relationship between curing temperature and reflectance for circularly polarized light.

In Example 4, a 35% toluene solution of a cholesteric liquid crystal monomer (cholesteric liquid crystal solution) was prepared by blending an ultraviolet-curing nematic liquid crystal and a chiral agent, as in the above-described Example 1. The amount of the chiral agent for the nematic liquid crystal was controlled so that the central wavelength of the selective reflection wave range of the cholesteric liquid crystal solution was 550 nm. To this cholesteric liquid crystal solution were added, as the photopolymerization initiator, Irg 907 (available from Ciba Specialty Chemicals K.K., Japan) in an amount of 5% of the cholesteric liquid crystal, and, as the surface-active agent, Byk 361 (manufactured by BYK-Chemie Japan K.K., Japan) in an amount of 0.06% of the cholesteric liquid crystal.

This cholesteric liquid crystal solution was applied, by the use of a spinner, to a glass substrate with an aligned polyimide film, and a plurality of circularly-polarized-light-separating elements, each comprising a single cholesteric liquid crystal film (film thickness: approximately 2 μm), were obtained in the same manner as in the aforementioned Example 1 by gradually varying the temperature at which ultraviolet light was applied.

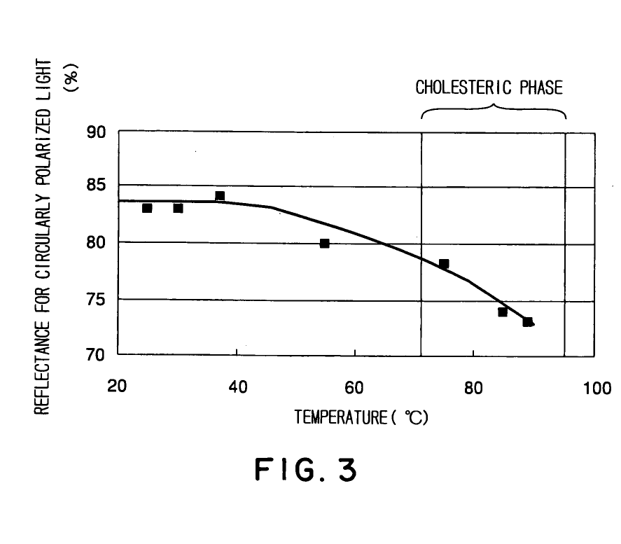

FIG. 3 is a graph showing a relationship between curing temperature and reflectance for circularly polarized light (reflectance for right-handed circularly polarized light at 550 nm that was equal to the central wavelength), obtained from these cholesteric liquid crystal films.

As shown in FIG. 3, it is understood that the reflectance for circularly polarized light is saturated at temperatures below approximately 40° C. (namely, at temperatures that are 30° C. or more lower than the lower limit of a temperature range (70 to 95° C.) in which liquid crystalline molecules of the cholesteric liquid crystal of Example 4 form a non-supercooled cholesteric phase) and that it is nearly constant at temperatures below approximately 30° C. (namely, at temperatures that are 40° C. or more lower than the lower limit of a temperature range (70 to 95° C.) in which liquid crystalline molecules of the cholesteric liquid crystal of Example 4 form a non-supercooled cholesteric phase).

### Example 5

By blending an ultraviolet-curing nematic liquid crystal and a chiral agent, six 35% toluene solutions of the cholesteric liquid crystal monomer (cholesteric liquid crystal solutions) were prepared. Namely, by varying the amount of the chiral agent for the nematic liquid crystal, six cholesteric liquid crystal solutions having different selective reflection wave ranges were prepared. The central wavelengths of the selective reflection wave ranges of these cholesteric liquid crystal solutions are shown in Table 1.

TABLE 1

| Layer | Central Wavelength (nm) of Reflectance |
|---|---|
| Number | for Circularly Polarized Light |
| 1 | 432 |
| 2 | 477 |
| 3 | 527 |
| 4 | 579 |
| 5 | 640 |
| 6 | 711 |

To each cholesteric liquid crystal solution were added, as the photopolymerization initiator, Irg 907 (available from Ciba Specialty Chemicals K.K., Japan) in an amount of 5% of the cholesteric liquid crystal, and, as the surface-active agent, Byk 361 (manufactured by BYK-Chemie Japan K.K., Japan) in an amount of 0.06% of the cholesteric liquid crystal.

The above-described six cholesteric liquid crystal solutions were then successively applied, in the order of No. 1 to No. 6 in the above Table 1, to a glass substrate that had been subjected to alignment treatment, thereby successively forming six cholesteric liquid crystal films.

Specifically, the first cholesteric liquid crystal solution was applied, by the use of a spinner, to a glass substrate with an aligned polyimide film, and was then dried at a temperature of 90° C. in order to remove the solvent (toluene) from it, thereby obtaining an uncured cholesteric liquid crystal film.

The uncured cholesteric liquid crystal film was then cooled, together with the glass substrate, to room temperature (25° C.), whereby the phase of this film was brought to a supercooled cholesteric one.

Thereafter, the cholesteric liquid crystal film in such a state was placed in an atmosphere of nitrogen and was irradiated, at a temperature of 25° C., with ultraviolet light with an irradiation power of 3.6 mW/cm² (310 nm) for 30 seconds.

By using the above-described film-forming method, the second and later cholesteric liquid crystal solutions were successively applied directly to the underlying cholesteric liquid crystal film. Thus, there was obtained a circularly-polarized-light-separating element comprising a laminate of the six, cholesteric liquid crystal films of the first to sixth cholesteric liquid crystal solutions.

The circularly-polarized-light-separating element obtained in this manner was a semi-transmission film capable of reflecting approximately 80% of right-handed circularly polarized light in a wave range between 420 nm and 750 nm. The thickness of each cholesteric liquid crystal film was determined so that the cholesteric liquid crystal film had a reflectance of 80% for circularly polarized light in its reflection wave range. The total film thickness of the circularly-polarized-light-separating element thus obtained was 10.7 μm

### Comparative Example 1

In Comparative Example 1, a circularly-polarized-light-separating element comprising a single cholesteric liquid crystal film (film thickness: approximately 1.85 μm) was obtained in the same manner as in the above-described Example 1, using the same cholesteric liquid crystal solution as in Example 1, provided that the temperature (curing temperature) at the time of application of ultraviolet light was changed from room temperature (25° C.) to 80°. This circularly-polarized-light-separating element was found to have a reflectance of 80% for circularly polarized light in a reflection wave range centered at 450 nm.

### Comparative Example 2

In Comparative Example 2, a circularly-polarized-light-separating element comprising a single cholesteric liquid crystal film (film thickness: approximately 3 μm) was obtained in the same manner as in the above-described Example 2, using the same cholesteric liquid crystal solution as in Example 2, provided that the temperature (curing temperature) at the time of application of ultraviolet light was changed from room temperature (25° C.) to 80°. This circularly-polarized-light-separating element was found to have a reflectance of 80% for circularly polarized light in a reflection wave range centered at 550 nm.

### Comparative Example 3

In Comparative Example 3, a circularly-polarized-light-separating element comprising a single cholesteric liquid crystal film (film thickness: approximately 3.2 μm) was obtained in the same manner as in the above-described Example 3, using the same cholesteric liquid crystal solution as in Example 3, provided that the temperature (curing temperature) at the time of application of ultraviolet light was changed from room temperature (25° C.) to 80°. This circularly-polarized-light-separating element was found to have a reflectance of 80% for circularly polarized light in a reflection wave range centered at 600 nm.

### Comparative Example 4

In Comparative Example 4, a circularly-polarized-light-separating element comprising six cholesteric liquid crystal films was obtained in the same manner as in the above-described Example 5, using the same six cholesteric liquid crystal solutions as in Example 5, provided that the temperature (curing temperature) at the time of application of ultraviolet light was changed from room temperature (25° C.) to 80°.

The circularly-polarized-light-separating element obtained in this manner was, as in Example 5, a semi-transmission film capable of reflecting approximately 80% of right-handed circularly polarized light in a wave range between 420 nm and 750 nm. The film thickness of each cholesteric liquid crystal film was determined so that the cholesteric liquid crystal film had a reflectance of 80% for circularly polarized light in its reflection wave range. The total film thickness of the circularly-polarized-light-separating element thus obtained was 15.7 μm

(Results of Evaluation)

The spectral properties of the circularly-polarized-light-separating elements of Examples 1 to 3 were compared with those of the circularly-polarized-light-separating elements of Comparative Examples 1 to 3. All of these circularly-polarized-light-separating elements reflected approximately 80% of right-handed circularly polarized light in a reflection wave range centered at 550 nm and showed nearly the same optical properties. On the other hand, the thicknesses of the former circularly-polarized-light-separating elements were compared with those of the latter ones. As a result, it was found that the circularly-polarized-light-separating elements of Examples 1 to 3 were approximately 30% thinner than those of Comparative Examples 1 to 3.

Further, the spectral properties of the circularly-polarized-light-separating element of Example 5 were compared with those of the circularly-polarized-light-separating element of Comparative Example 4. These two circularly-polarized-light-separating elements reflected approximately 80% of right-handed circularly polarized light in a wave range between 420 nm and 750 nm and showed nearly the same optical properties. On the other hand, the circularly-polarized-light-separating element of Example 5 had a thickness of 10.7 μm, and that of Comparative Example 4 had a thickness of 15.7 μm: the thickness of the circularly-polarized-light-separating element of Example 5 was thus approximately 30% smaller than that of the

circularly-polarized-light-separating element of Comparative Example 4.

What is claimed is:

1. A process of producing a circularly-polarized-light-separating element, comprising:
a first step of applying, to a substrate having alignment power, a cholesteric liquid crystal solution prepared by dissolving a radiation-polymerizable cholesteric liquid crystalline material in a solvent, thereby forming a film;
a second step of removing the solvent from the film formed in the first step, thereby obtaining an uncured cholesteric liquid crystal film; and
a third step of applying, for curing, radiation to the uncured cholesteric liquid crystal film formed in the second step, while holding a phase of this film to a supercooled cholesteric one, thereby obtaining a cured cholesteric liquid crystal film.

2. The process according to claim 1, wherein, in the third step, the phase of the uncured cholesteric liquid crystal film formed in the second step is held to a supercooled cholesteric one with liquid crystalline molecules in planar orientation.

3. The process according to claim 1, wherein, in the third step, the uncured cholesteric liquid crystal film formed in the second step is held at a temperature that is 30-90° C. lower than a lower limit of a temperature range in which liquid crystalline molecules in the liquid crystal film form a non-supercooled cholesteric phase.

4. The process according to claim 1, further comprising, between the second and third steps, a fourth step of leaving, as it is, the uncured cholesteric liquid crystal film formed in the second step for a predetermined period of time so that the phase of this film is brought to a supercooled cholesteric one with liquid crystalline molecules in planar orientation.

5. The process according to claim 4, wherein, in the fourth step, the uncured cholesteric liquid crystal film formed in the second step is heated.

6. The process according to claim 1, further comprising:
a fifth step of applying, to the cured cholesteric liquid crystal film formed on the third step, an additional cholesteric liquid crystal solution prepared by dissolving a radiation-polymerizable cholesteric liquid crystalline material in a solvent, thereby forming an additional film;
a sixth step of removing the solvent from the additional film formed in the fifth step, thereby obtaining an uncured additional cholesteric liquid crystal film; and
a seventh step of applying, for curing, radiation to the uncured additional cholesteric liquid crystal film formed in the sixth step, while holding a phase of this film to a supercooled cholesteric one, thereby obtaining a cured additional cholesteric liquid crystal film.

7. The process according to claim 6, wherein, in the third and seventh steps, the phases of the uncured cholesteric liquid crystal films respectively formed in the second and sixth steps are held to supercooled cholesteric ones with liquid crystalline molecules in planar orientation.

8. The process according to claim 6, wherein, in the third and seventh steps, the uncured cholesteric liquid crystal films respectively formed in the second and sixth steps are held at temperatures that are 30-90° C. lower than lower limits of temperature ranges in which liquid crystalline molecules in the liquid crystal films form non-supercooled cholesteric phases.
